(19) United States
(12) Patent Application Publication
(10) Pub. No.: US 2020/0298175 A1
(43) Pub. Date: Sep. 24, 2020

(54) COMPOSITION FOR CONTROLLING AMBIENT HUMIDITY

(71) Applicant: SHANGHAI HENGYUAN MACROMOLECULAR MATERIAL CO., LTD., SHANGHAI (CN)

(72) Inventor: SANDRA SHEN, SHANGHAI (CN)

(21) Appl. No.: 16/084,972

(22) PCT Filed: Jul. 20, 2018
(86) PCT No.: PCT/CN2018/096458

§ 371 Date: Sep. 14, 2018

(30) Foreign Application Priority Data
Jun. 29, 2018 (CN) 201810700475.X

(51) Int. Cl. B01D 53/28; B01D 53/26

(52) U.S. Cl. CPC B01D 53/28; B01D 2252/10; B01D 53/263

(57) ABSTRACT

A composition for controlling an ambient humidity within 65%-75%. The composition includes at least one chloride salt and water. The chloride salt includes at least one of NaCl, NH₄Cl, KCl and MgCl₂. The weight percentage of the chloride salt in the humidity control composition is 12%-29.75%. The composition can control the ambient humidity within 65%-75% without the need to pre-adjust the objective space. The composition has a large capacity of moisture absorption and desorption, and can quickly achieve the desired humidity in the objective environment.

### RELATED APPLICATIONS

This application is a § 371 application from PCT/CN2018/096458 filed Jul. 20, 2018, which claims priority from Chinese Patent Application No. 201810700475.X filed Jun. 29, 2018, each of which is herein incorporated by reference in its entirety.

### FIELD OF THE INVENTION

The present invention relates specifically to a composition for controlling ambient humidity.

### BACKGROUND OF THE INVENTION

“Humidity” is an important factor that affects product packaging and storage life in all walks of life. Each product requires a reasonable humidity range to store. For example, the humidity to store cigar products is about 69%, the ambient humidity below the numerical value will make the internal moisture of the cigar products too low and then accelerate the ageing of the cigar products, and the ambient humidity above the numerical value will cause the cigar products rot and then damage the taste of the cigar products. The humidity to store some seeds is about 65%-75%, the ambient humidity below the numerical value will cause the seeds to dry out and to be moth-eaten, and the ambient humidity above the numerical value will cause the seeds to become moldy and then lose their vitality. The humidity to store frozen meat food is within 65%-75%, the ambient humidity below the numerical value will cause the frozen meat food to dry up, and the ambient humidity above the numerical value will make food sticky and slip, promote bacterial growth and accelerate food spoilage.

In order to control the ambient humidity within 65%-75%, the common method is to use humidity control silica gel to control the ambient humidity. However, the use of humidity control silica gel is not in line with green products. During the manufacture of humidity control silica gel, a lot of wastewater will be produced. In order to protect the environment, many silicone raw material factories are closed for rectification. This has led various industries to start to comprise desiccant product, which is the least important in the original list of materials table, in the procurement list of important materials.

Therefore, there is an urgent need for an alternative to humidity control silica gel, and the alternative must be in line with the green and environment theme.

### SUMMARY OF THE INVENTION

The present invention is made for solving the foregoing problems and aims to provide a composition for use in controlling ambient humidity.

The present invention provides a composition for use in controlling ambient humidity within 65%-75%, comprising: at least one of chloride salt and water, wherein the chloride salt comprises at least one of NaCl, NH₄Cl, KCl and MgCl₂, the weight percentage of the chloride salt in the composition is 12%-29.75%.

Further, the composition for use in controlling ambient humidity can also have the following features: wherein the composition for use in controlling ambient humidity comprises one of chloride salt, the chloride salt is NaCl, the weight percentage of the chloride salt in the composition is 12%-26.80%.

Further, the composition for use in controlling ambient humidity can also have the following features: wherein the composition for use in controlling ambient humidity comprises two kinds of the chloride salt, one of the chloride salt is any one of KCl and NH₄Cl and the other one of the chloride salt is NaCl, the weight percentage of the NaCl in the composition is 7%-16%, the weight percentage of the NH₄Cl in the composition is 5%-13.75%, the weight percentage of the KCl in the composition is 2%-10.5%.

Further, the composition for use in controlling ambient humidity can also have the following features: wherein the weight percentage of the NaCl in the composition is 11%-15%, the weight percentage of the NH₄Cl in the composition is 8%-12%, the weight percentage of the KCl in the composition is 3%-8%.

Further, the composition for use in controlling ambient humidity can also have the following features: wherein the weight percentage of the NaCl in the composition is 14%-14.8%, the weight percentage of the NH₄Cl in the composition is 10%-11.4%, the weight percentage of the KCl in the composition is 5%-7.4%.

Further, the composition for use in controlling ambient humidity can also have the following features: wherein the composition for use in controlling ambient humidity comprises two kinds of the chloride salt, one of the chloride salt is KCl and the other one of the chloride salt is MgCl₂, the weight percentage of the MgCl₂ in the composition is 6%-17%, the weight percentage of the KCl in the composition is 3%-15%, the total weight percentage of the chloride salt in the composition is 12%-29.75%.

### THE EFFECT OF THE PRESENT INVENTION

The composition for use in controlling ambient humidity according to the present invention comprises: at least one of chloride salt and water, wherein the chloride salt comprises at least one of NaCl, NH₄Cl, KCl and MgCl₂, the weight percentage of the chloride salt in the composition is 12%-29.75%. Therefore, the composition for use in controlling ambient humidity of the present invention can control the ambient humidity within 65%-75%, does not need to pre-adjust the objective space, has large capacity of moisture absorption and desorption and can quickly achieve the desired humidity in the objective environment.

Moreover, since the composition for use in controlling ambient humidity of the present invention comprises only chloride salt in common, the composition manufactured by using the chloride salt is not only cheap, but also safe for human body when manufacturing, environment and the objects to be preserved. In addition, the composition is not only friendly to the natural environment in the manufacturing process, but also friendly to the natural environment after being discarded.

### DETAILED DESCRIPTION OF THE PREFERRED EMBODIMENTS

### Embodiment 1

The composition for use in controlling ambient humidity within 65%-75% comprises NaCl and water, the weight percentage of the NaCl in the composition is 12%-26.80%.

The purity of the NaCl is not less than 99.9%. The water is deionized water.

### Embodiment 2

The composition for use in controlling ambient humidity within 65%-75% comprises KCl, NaCl and water. The weight percentage of the NaCl in the composition is 7%-16%, the weight percentage of the KCl in the composition is 2%-10.5%.

The purity of the NaCl and the KCl are all food grade purity (the purity is not less than 99.9%). The water is deionized water.

When the weight percentage of the NaCl and the KCl is greater than the percentage range, crystallization is easy to occur in the composition which requires high temperature to dissolve, resulting in high loss and making the weight of the composition being unstable. When the weight percentage of the NaCl and the KCl is lower than the percentage range, it takes much longer time to manufacture the composition for use in controlling ambient humidity and the humidity control capability will decrease.

### Embodiment 3

The composition for use in controlling ambient humidity within 65%-75% comprises NH₄Cl, NaCl and water. The weight percentage of the NaCl in the composition is 7%-16%, the weight percentage of the NH₄Cl in the composition is 5%-13.75%.

The purity of the NaCl is food grade purity (the purity is not less than 99.9%). The purity of the NH₄Cl is not less than 99.9%. The water is deionized water.

### Embodiment 4

The composition for use in controlling ambient humidity within 65%-75% comprises KCl, NaCl and water. The weight percentage of the NaCl in the composition is 11%-15%, the weight percentage of the KCl in the composition is 2%-7.5%.

The purity of the NaCl and the KCl are all food grade purity (the purity is not less than 99.9%). The water is deionized water.

### Embodiment 5

The composition for use in controlling ambient humidity within 65%-75% comprises NH₄Cl, NaCl and water. The weight percentage of the NaCl in the composition is 11%-15%, the weight percentage of the NH₄Cl in the composition is 8%-12%.

The purity of the NaCl is food grade purity (the purity is not less than 99.9%). The purity of the NH₄Cl is not less than 99.9%. The water is deionized water.

### Embodiment 6

The composition for use in controlling ambient humidity within 65%-75% comprises KCl, NaCl and water. The weight percentage of the NaCl in the composition is 14%-14.8%, the weight percentage of the KCl in the composition is 3%-5.4%.

The purity of the NaCl and the KCl are all food grade purity (the purity is not less than 99.9%). The water is deionized water.

### Embodiment 7

The composition for use in controlling ambient humidity within 65%-75% comprises NH₄Cl, NaCl and water. The weight percentage of the NaCl in the composition is 14%-14.8%, the weight percentage of the NH₄Cl in the composition is 10%-11.4%.

The purity of the NaCl is food grade purity (the purity is not less than 99.9%). The purity of the NH₄Cl is not less than 99.9%. The water is deionized water.

### Embodiment 8

The composition for use in controlling ambient humidity within 65%-75% comprises KCl, MgCl₂ and water. The weight percentage of the KCl in the composition is 3%-15%, the weight percentage of the MgCl₂ in the composition is 6%-17%, the total weight percentage of the chloride salt in the composition is 12%-29.75%.

The purity of the KCl is food grade purity (the purity is not less than 99.9%). The MgCl₂ is anhydrous magnesium chloride and the purity of the MgCl₂ is not less than 99.9%. The water is deionized water.

Take the embodiment 7 as an example, the weight percentage of NaCl, NH₄Cl and water in the composition for controlling different humidity, respectively is

| Ambient humidity | | | |
|---|---|---|---|
| (%) | Nacl (%) | NH₄Cl (%) | H₂O (%) |
| 65 | 14 | 11.4 | 74.6 |
| 69 | 14 | 11 | 75 |
| 71 | 14.6 | 10 | 75.4 |
| 75 | 14.8 | 10 | 75.2 |

### The Effect of the Embodiments

The composition for use in controlling ambient humidity according to the foregoing embodiments comprises: at least one of chloride salt and water, wherein the chloride salt comprises at least one of NaCl, NH₄Cl, KCl and MgCl₂, the weight percentage of the chloride salt in the composition is 12%-29.75%. Therefore, the composition for use in controlling ambient humidity of the foregoing embodiments can control the ambient humidity within 65%-75%, does not need to pre-adjust the objective space, has large capacity of moisture absorption and desorption and can quickly achieve the desired humidity in the objective environment.

Moreover, since the composition for use in controlling ambient humidity of the foregoing embodiments comprises only chloride salt in common, the composition manufactured by using the chloride salt is not only cheap, but also safe for human body when manufacturing, environment and the objects to be preserved. In addition, the composition is not only friendly to the natural environment in the manufacturing process, but also friendly to the natural environment after being discarded.

The foregoing embodiments are preferred cases of the present invention and is not used to limit the scope of protection of the present invention.

1. A composition for controlling an ambient humidity within 65%-75%, comprising:
a chloride salt and water;
wherein the chloride salt comprises at least one of NaCl, NH₄Cl, KCl and MgCl₂;
a weight percentage of the chloride salt in the composition is 12%-29.75%.

2. The composition for controlling the ambient humidity according to claim 1, wherein the composition comprises one of the chloride salts, the chloride salt being the NaCl; and the weight percentage of the chloride salt in the composition is 12%-26.80%.

3. The composition for controlling the ambient humidity according to claim 1, wherein the composition comprises two of the chloride salts, a first chloride salt is one of the KCl and the NH₄Cl, and a second chloride salt is the NaCl; wherein a weight percentage of the NaCl in the composition is 7%-16%; wherein a weight percentage of the NH₄Cl in the composition is 5%-13.75%, and wherein a weight percentage of the KCl in the composition is 2%-10.5%.

4. The composition for controlling the ambient humidity according to claim 3, wherein the weight percentage of the NaCl in the composition is 11%-15%; wherein the weight percentage of the NH₄Cl in the composition is 8%-12%; and wherein the weight percentage of the KCl in the composition is 3%-8%.

5. The composition for controlling the ambient humidity according to claim 4, wherein the weight percentage of the NaCl in the composition is 14%-14.8%; wherein the weight percentage of the NH₄Cl in the composition is 10%-11.4%; and wherein the weight percentage of the KCl in the composition is 5%-7.4%.

6. The composition for controlling the ambient humidity according to claim 1, wherein the composition comprises two of the chloride salts, a first chloride salt is the KCl, and a second chloride salt is the MgCl₂; wherein a weight percentage of the MgCl₂ in the composition is 6%-17%; wherein a weight percentage of the KCl in the composition is 3%-15%; and wherein a total weight percentage of the chloride salts in the composition is 12%-29.75%.
